(19) United States
(12) Patent Application Publication
(10) Pub. No.: US 2026/0076869 A1
(43) Pub. Date: Mar. 19, 2026

(54) Pressure Wave Apparatus With Double Valve Means

(71) Applicant: STORZ MEDICAL AG, Tägerwilen (CH)

(72) Inventors: Rafael Storz, Kreuzlingen (CH); Markus Belau, Konstanz (DE); Arvid Kühl, Tägerwilen (CH); Lukas Honsell, Reichenau (DE); Felix Gremlich, Kreuzlingen (CH); Thomas Glenzer, Kreuzlingen (CH)

(21) Appl. No.: 19/106,361

(22) PCT Filed: Aug. 16, 2023
(86) PCT No.: PCT/EP2023/072559

§ 371 Date: Feb. 25, 2025

(30) Foreign Application Priority Data
Aug. 25, 2022 (EP) 22192134.9

(51) Int. Cl. A61H 23/04

(52) U.S. Cl. CPC A61H 23/04; A61H 2201/1238; A61H 2201/5056; A61H 2203/03

(57) ABSTRACT

Apparatus for treatment with pressure waves, comprising: a projectile guided along the movement path, an applicator and a stop, pneumatic means for application of pressure to the projectile for the purpose of movement, wherein the projectile is adapted for striking onto the applicator, which pneumatic means comprises a double valve means for application of pressure to the projectile towards the applicator during a first activation time and in the reverse direction during a second activation time, and a control means adapted, after a partial return movement in a second activation time, to end this second activation time, to start a first activation time and, after only a part of the movement path, to reverse the movement from a return movement into a forward movement.

The invention relates to an apparatus for treatment of the human or animal body with mechanical pressure waves generated by impact of an accelerated projectile onto an applicator.

Apparatus of this type have been known for some time and are increasingly in use. Mechanical pressure waves are used for treatment of the (human or animal) patient, which are coupled-in by placing an applicator onto the patient's body and are generated by a collision of an accelerated projectile with the applicator. The applicator does not necessarily have to be in one piece but can also be composed of a number of different parts or materials.

A technique for accelerating the projectile, which has been proven in practice and has been described many times, is pneumatic. A pneumatic overpressure is coupled-in by application of a pressure to a volume on one side of the projectile movable along a movement path, for example in a pipe segment.

In the prior art, a switching valve is used for this purpose, which is connected to a pneumatic supply, in particular a compressor with adjustable output pressure, and the pulse of which accelerates the projectile from an end of the movement path distal to the applicator towards the applicator. The pneumatic application is switched off when the proximal end of the movement path is reached, i.e., with the impact on the applicator.

In the prior art, the return movement takes place with the aid of a counter-pressure chamber, i.e., a storage volume, into which the projectile moved towards the applicator to a certain extent displaces the air located in front of it, whereby it virtually pumps up this storage volume.

In the prior document EP 2 181 730 B1, which, however, was revoked because of lack of reproducibility in opposition appeal proceedings, in addition to a control of the opening time of the switching valve for the acceleration, which is not explained in more detail, a targeted pressure limitation in this counter-pressure chamber is also discussed. Furthermore, this document mentions the use of a second switching valve for a return of the projectile into the distal starting position after the application by the first switching valve.

The present invention is based on the object of specifying an apparatus of the described type with pneumatic means for projectile movement on this basis, which apparatus is improved with regard to the back and forth movement of the projectile.

In order to achieve this object, the apparatus according to claim 1 is proposed. Preferred configurations are the subject matter of the dependent claims.

Accordingly, the apparatus according to the invention has, as part of its pneumatic means, a double valve means for application of the projectile in both directions, i.e., towards the applicator and vice versa away from it in the reverse direction, i.e., for example the combination of a first and a second valve. The time phases in which the projectile is applied pneumatically in such a way that it moves in the forward direction, i.e., for example the activation phase of a first valve, is referred to below as the first activation time and vice versa as the second activation time a time phase of a reversed application of the projectile.

According to the invention, the apparatus is to be adapted (i.e., in particular a control means present therein is to be adapted) in such a way as to end a second activation time already before the projectile has been moved back completely, i.e., after only a partial return movement. Moreover, the first activation time is also to begin already before the complete return and therefore also after only a partial return movement, but not necessarily simultaneously with the end of the second activation time. Overall, it can and should thus be achieved that the projectile (in any rate in certain control states) no longer moves back completely at all, but already reverses its movement path after a part of the movement path and before its end (with the stop).

According to the invention, therefore, by an early end of the second activation time and a start of the (following) first activation time even before reaching the distal end of the movement path, a shortening of the movement path to an effective length with respect to the geometrically possible movement path is achieved.

This results in different possibilities and advantages which can be used depending on the application. For example, the impact speed of the projectile onto the applicator can be varied and, in particular, controlled independently of the pneumatic pressure used. Specifically, the shorter the effective acceleration path (assuming constant accelerating pressure), the lower the impact speed. In this respect, the invention offers a further degree of freedom.

In particular, particularly low impact speeds which would not be accessible solely by a pressure reduction can be realized by the shortening of the effective acceleration path. Experience has shown that the pneumatic drives discussed here require a certain minimum pressure in order to be able to move the projectile in a defined manner at all. This can be, for example, the result of static friction between the projectile and the inner lateral surfaces of the pipe segment guiding it. According to the invention, in the case of a pressure which is sufficient for safe and defined projectile movement, the speed can now be lowered even further by shortening the path.

An additional advantage can consist in being able to increase the operating frequency at a given desired impact speed with respect to the conventional procedure (with utilization of the entire geometrically given movement path). Specifically, if the desired impact speed can be achieved with a pressure which is lower than the available pressure and, instead of a reduction of this pressure (for example by a pressure reducer or else by a controller of the pressure source), the effective movement path is shortened in the described manner, the projectile requires less time in each case for the forward movement and moreover also for the return movement.

The combination of two switching valves was addressed further above, which rep-resents a possibility for a double valve means provided according to the invention. In this variant, the two valves can be controlled (preferably independently of one another) by the control means. Alternatively, however, a uniform valve can also be used, which is referred to here as a “combination valve” and which, depending on the control by the control means, has at least two switching states, namely a first for application of pneumatic pressure to the projectile in the direction towards the applicator and a second for application of pneumatic pressure to the projectile in the reverse direction. While the combination valve is in the first switching state, there is therefore a first valve opening time and, accordingly, a second valve opening time in the second switching state.

In these two switching states, the pneumatic connection to be applied in the respectively other switching state is preferably ventilated by the combination valve, so that, for example, during the forward movement, approximately ambient pressure prevails on the side of the projectile proximal to the applicator and, in contrast to the conventional procedure with a counter-pressure chamber, there is no dynamic pressure increasing from collision to collision.

Even when using two separate valves, at least one of the two valves is preferably a two-way valve, which accordingly carries out a ventilation, provided that it is not switched for application of the pneumatic pressure.

The possibility of controlling the impact speed of the projectile by means of the part of the possible movement path actually used was already addressed further above. An additional possibility consists in allowing a first activation time (responsible for the pressurization of the projectile in the forward direction) to overlap with a subsequent or preceding second activation time (responsible for the pressurization in the opposite direction) during the acceleration of the projectile in the direction toward the applicator. During the time period of such an overlap, for example directly before the impact of the projectile onto the applicator, the pneumatic pressures on the two sides of the projectile are at least largely compensated, so that the projectile remains to some extent without force (apart from friction). In this respect, in this form, additional influence can be exerted on the impact speed, specifically without varying the amount of the pneumatic pressure applied.

For the combination valve described above, this means an additional switching state, in which pressurization takes place on both sides.

A combination of the two possibilities, i.e. the use of only a part or even variation of the part of the movement path used, on the one hand, and an overlap of the activation times of the two valves, on the other hand, can certainly be meaningful. For example, a limitation of the impact speed can be achieved with an overlap time period before the impact of the projectile onto the applicator, wherein (in comparison with an acceleration over the entire movement path) the averaged speed nevertheless remains relatively high. If, namely, acceleration is initially performed and then acceleration is no longer performed during the overlap time period, a higher speed level is achieved comparatively early than in the case of a continuous acceleration until the collision (assuming the same collision speed). If, therefore, for example, with a minimum acceleration pressure, on the one hand, a particularly low impact speed is also intended to be realized (as explained above), but without increasing the frequency (too much) in the process, an acceleration can take place, for example, in the initial phase of the forward movement in a first activation time and this can then be ended by an overlap of the two activation times. It then remains (quite approximately) at the projectile speed achieved, but more time elapses until the collision, to some extent by a distance not used for the acceleration. Therefore, the overlap time offers an additional degree of freedom within the scope of the invention.

Of course, control states with different such overlap times can exist in this case, including an overlap time zero. Moreover, there can principally also be an overlap time after the collision. If, exceptionally, the complete movement path is used, there can also be, in principle, an overlap time or a portion of an overlap time after the movement reversal at the distal end of the movement path. In the case of a repetitive movement, the projectile can be virtually reflected at this end and start the movement in the forward direction already as a result of the pulse exchange.

Moreover, in the case of a given pneumatic pressure, too high a reverse acceleration and collision of the projectile with a stop at an end of the movement path distal from the applicator can be avoided if the full movement path is used in the relevant control state (exceptionally). Moreover, the time for the return movement can be lengthened by an overlap time period after the collision, without thus increasing the movement path actually used, if this is desired with regard to a specific combination of frequency and impact speed (in the case of a given pressure).

In particular, during the variation of an overlap time of the two activation times, the second activation time can be varied with regard to its duration and/or its start, wherein the first activation time can preferably remain constant in this case.

A further possibility for other control states and, in this sense, to some extent the opposite of the described overlap time is a separation time between the first and the second activation time, or vice versa, wherein, in this sense, a separation time between a first and the subsequent second activation time is meant here (and not vice versa, that is to say in the sense of the sequence of a first activation time to a second in the vicinity of a distal reversal point of the projectile movement).

Such a separation time leads, in a manner similar to the overlap time, to a virtually force-free movement moment of the projectile and can thus be used in a similar manner, wherein, in the case of an apparatus, control states with overlap time and other control states with separation time (and possibly also those with direct contact of the first and the second activation time in the sense of a separation time zero) can also exist.

In particular, therefore, in the case of a separation time, the projectile speed during impact can be reduced. Moreover, during the return movement, a certain deceleration can be achieved if the or a portion of the separation time lies after the impact. This has already been explained above in a similar form for the overlap time.

In the above explanations, attention has repeatedly been paid to not necessarily having to change the pneumatic pressure. It is indeed preferred to maintain this pressure unchanged during the operation and in different control states.

In the simplest case, the pneumatic means can comprise a connection for supply from a pneumatic line network, for example in a hospital, or from a compressed gas cylinder. However, preference is given to a pneumatic compressor with which the apparatus according to the invention is locally independent and more mobile in comparison with a compressed gas cylinder. Pneumatic compressors are already known per se in conjunction with such apparatuses. However, the invention offers the abovementioned aspect of not necessarily having to change the supply pressure in different control states with different impact speeds of the projectile. In other words, the compressor can run at the same rotational frequency in such different control states.

Of course, this can first of all simplify the controlling of the compressor, in particular if the latter principally runs at the same rotational frequency in the activated state. Furthermore, the compressor can be operated in the vicinity of its or at its maximum efficiency (with respect to the rotational frequency). Moreover, it is possible to match noise reduction measures, for example a damping mounting of the compressor or a noise-damping casing, to the vibration behavior of the compressor at the same rotational frequency.

A particular design possibility of the invention is based on being able to influence the impact physics between projectile and applicator directly and rapidly solely by changing valve opening times or valve opening time durations, in particular the impact speed. In comparison with a change in the supply pressure, this possibility of influencing is particularly rapid, such that, in an iterative operating state, in principle the impact speed and/or the time duration of the combined forward and return movement, that is to say a momentary frequency, can be changed from one impact process to the next. Such a rapid and free influencing or control action is not enabled by the prior art.

Typical impact speeds are in the range between 2 m/s and 30 m/s, but also in the case of conditions which change less rapidly or do not change. For impact physics, above all the impact pulse is important, which, in the case of typical projectile masses, can be between 1 g and 10 g, and therefore in a range between 2 gm/s and 300 gm/s, preferably between 10 gm/s and 150 gm/s.

In a particular configuration, the apparatus has a measuring means, with which the passage of the projectile can be measured at a point of its movement path. This measuring means is coupled to the control means. Therefore, in such a form, e.g. the passage of the projectile shortly before impact or quasi during impact onto the applicator can be detected, so that the activation times can be matched accordingly (in particular with regard to their start and their end) to the time of impact.

Such a detection can take place, for example, optically, for example, by a light barrier or the like, but preferably inductively using a measuring coil. This can detect the projectile by a residual magnetism of the projectile or purely inductively (by changing the leakage inductance).

The invention will be explained in more detail below on the basis of exemplary embodiments, wherein the individual features can also be essential to the invention in another combination within the scope of the claims.

In detail,

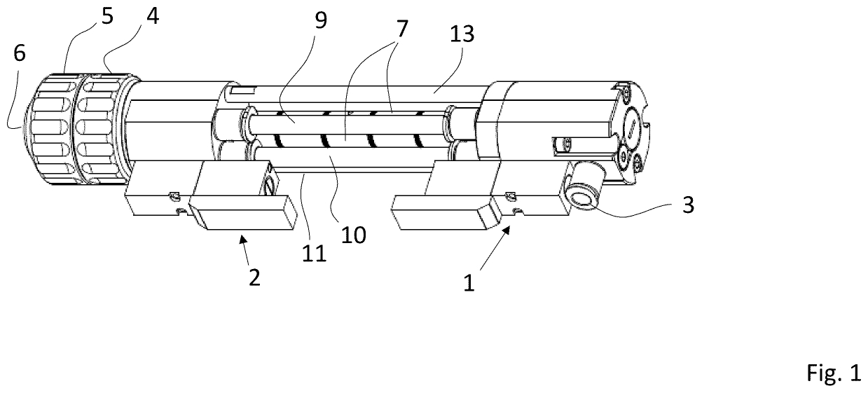

FIG. 1 shows a perspective illustration of an apparatus according to the invention, wherein a central housing part is omitted for the sake of clarity;

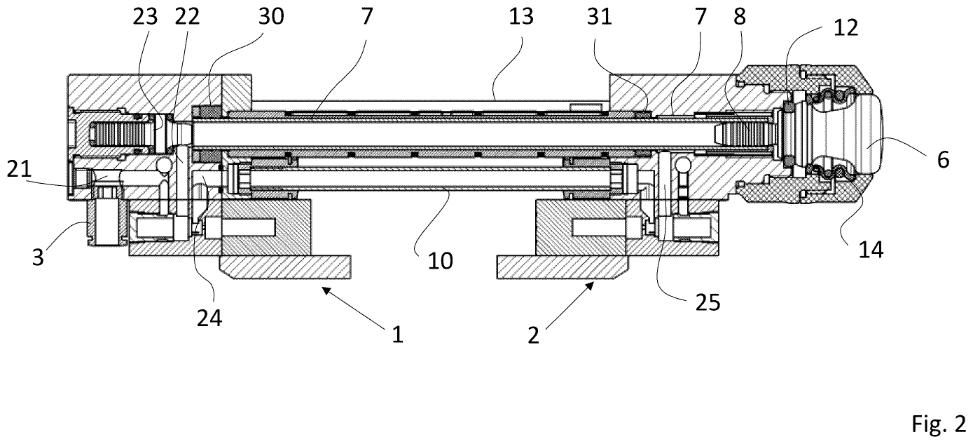

FIG. 2 shows a longitudinal section through the apparatus from FIG. 1 in the right-left-reversed position with respect to FIG. 1;

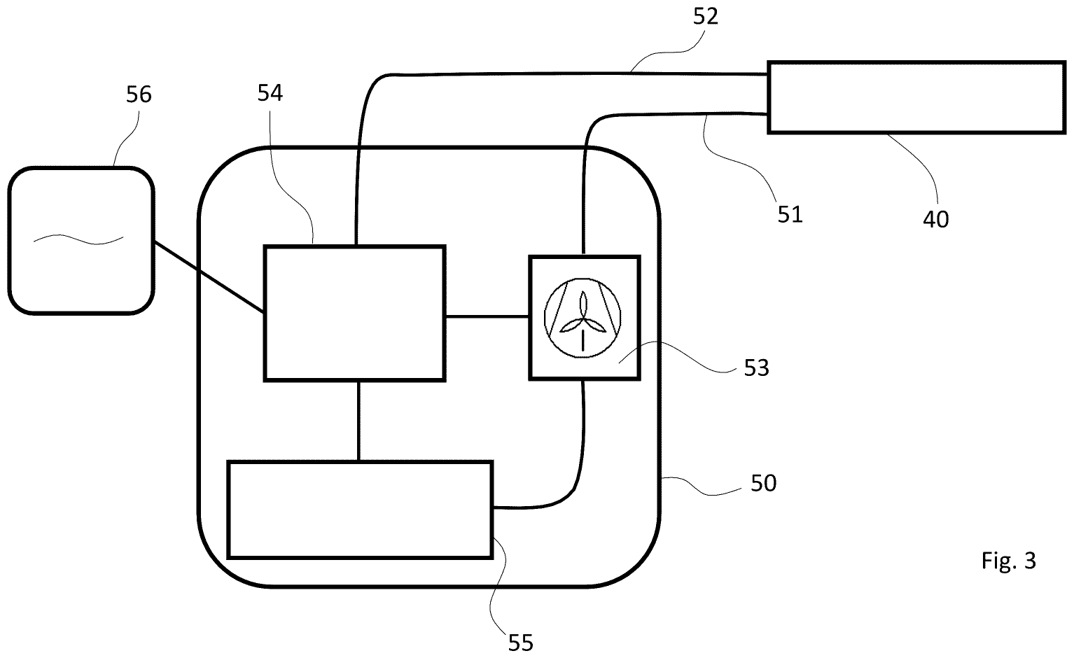

FIG. 3 shows a schematic diagram of the handpiece with an associated basic apparatus;

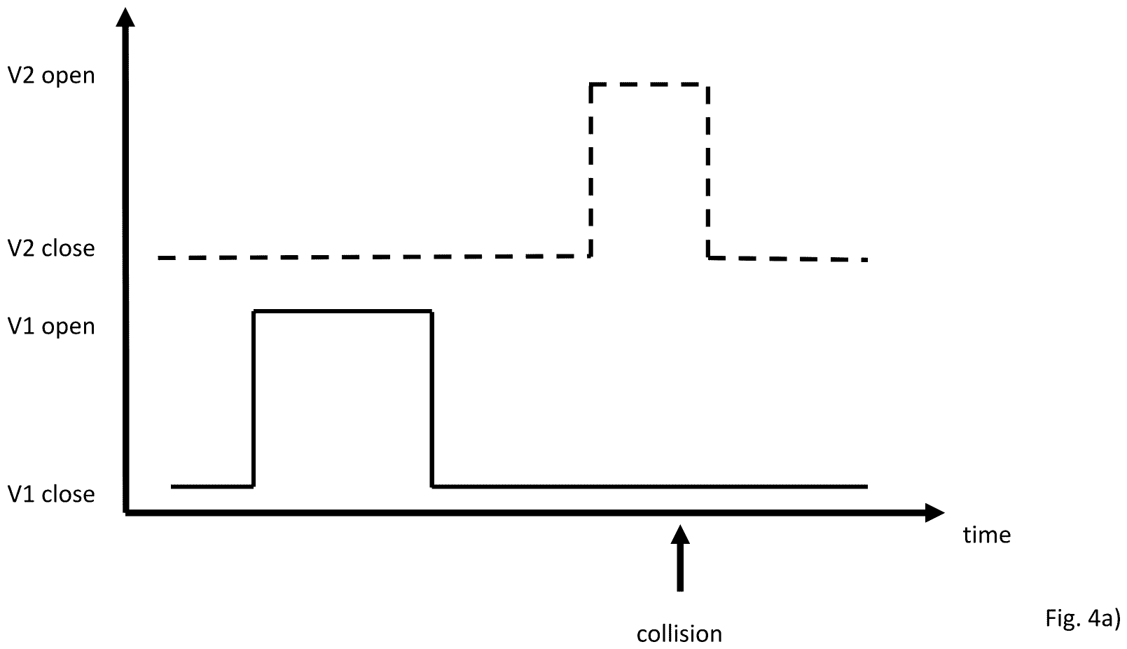

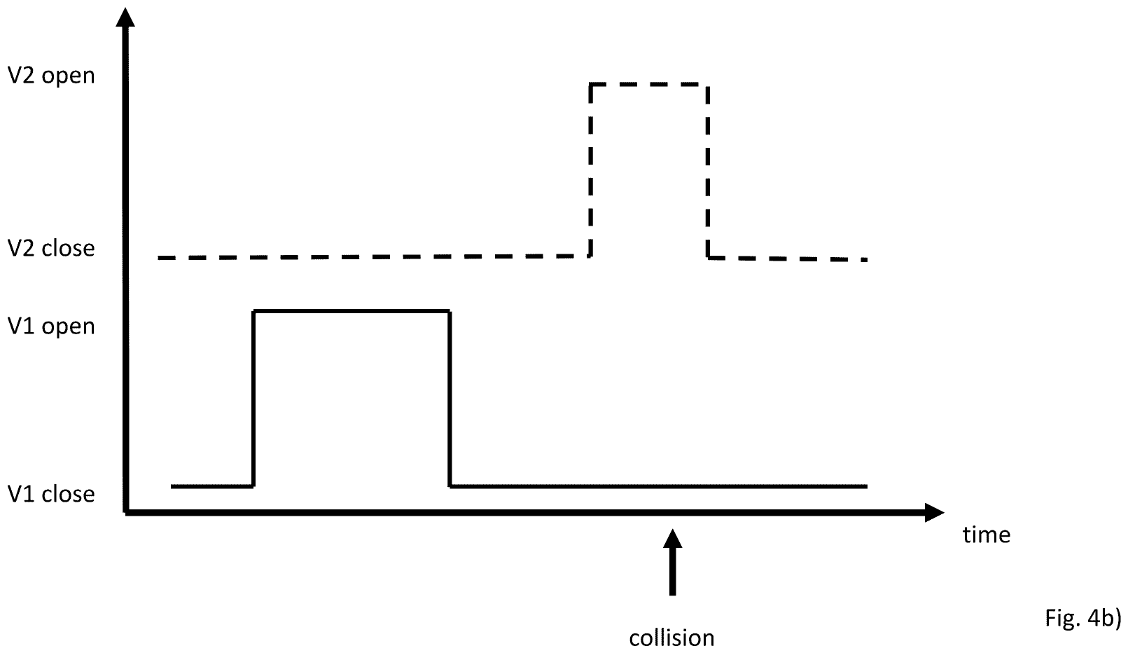

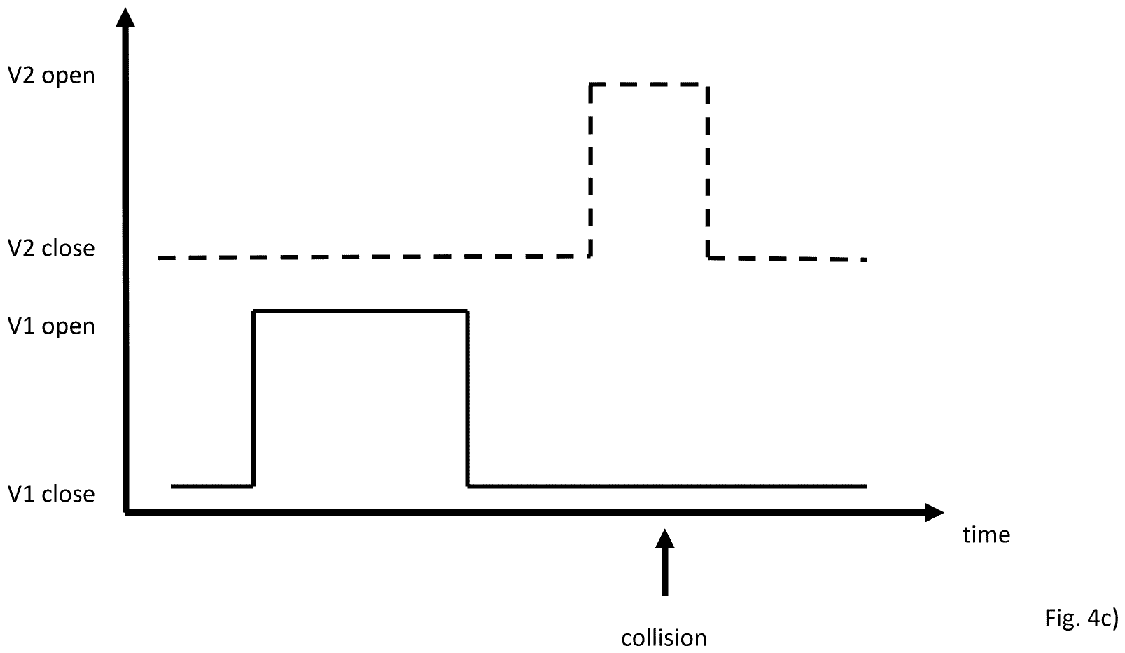

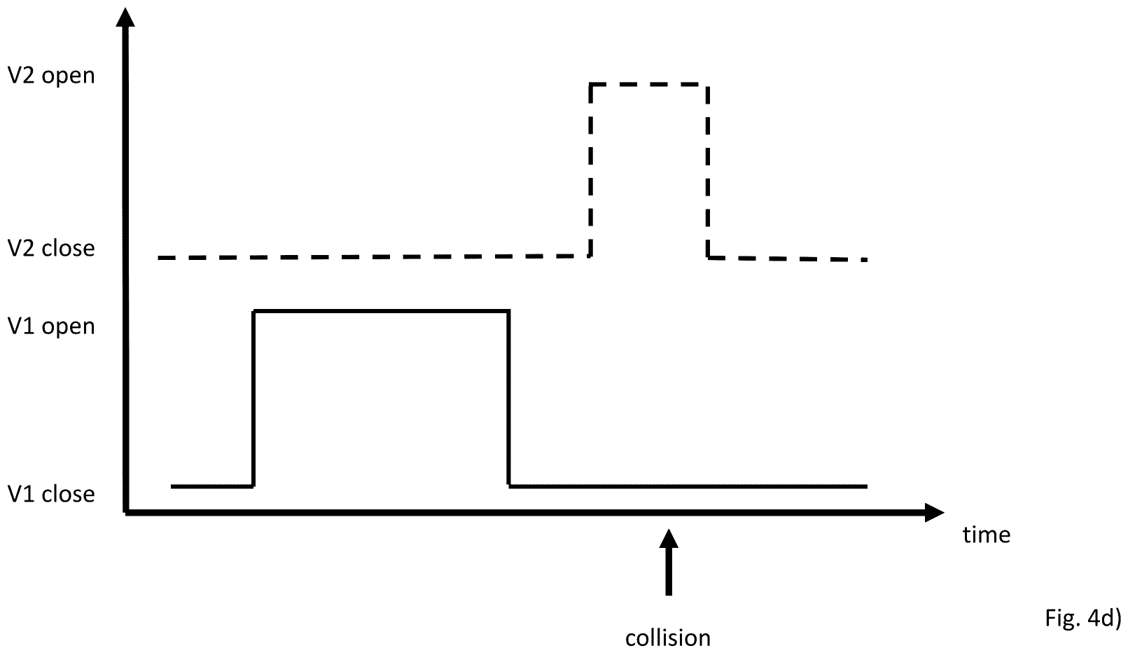

FIG. 4 shows a sequence of schematic time diagrams 4 a) to d) for explaining the mode of operation;

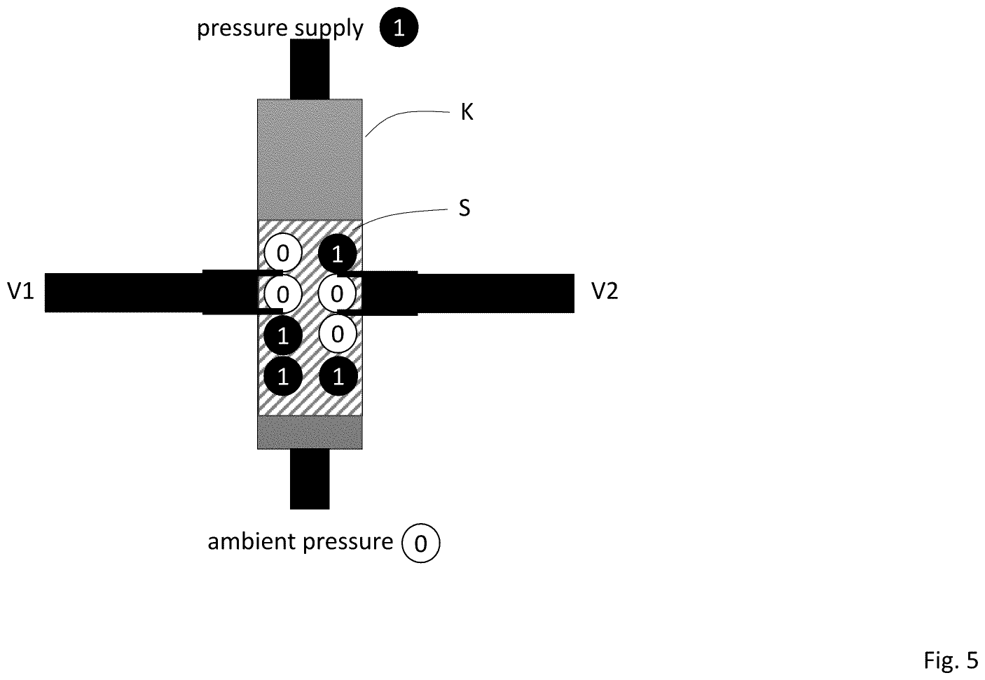

FIG. 5 shows a schematic illustration of a combination valve for explaining an alternative exemplary embodiment to FIGS. 1 and 2.

FIG. 1 shows a handpiece of an apparatus according to the invention in a perspective view with pneumatic valves pointing to the front-left, namely a first valve 1 and a second valve 2. A pneumatic supply connection 3 can be seen on the right and two screw rings 4 and 5, which are respectively corrugated on the outside for easier handling, for holding the applicator 6, which will be explained in more detail below, can be seen on the left. The latter can still be seen on the far left in FIG. 1 with its patient-facing surface and is otherwise shown in FIG. 2. It could also be constructed in multiple parts.

A number of tubes running in the transverse direction can be seen in the central region of the apparatus from FIG. 1, wherein the central tube with the reference numeral 7 contains and guides the projectile 8, which can be seen in section in FIG. 2. Two parallel pneumatic connecting pipelines 9 and 10 can be seen in front of this between the two valves 1 and 2, wherein the pipeline 9 serves for supplying a pressurization/pressure application to the second valve 2 and the pipeline 10 conversely serves for ventilation of this second valve 2 via an outlet provided in the first valve 1. In this exemplary embodiment, this number of pipes is surrounded by a housing cover 11, which is shown in FIG. 1 by the line below the pipeline 10 and the two lines above the projectile guide pipe 7. This housing cover 11 runs in the rear region in FIG. 1 and comprises only a part of the circumference. At its respective axial edges, it is designed in a manner similar to a flanging by means of a rounded turnover inwardly in a manner favorable to the grip, which is indicated in FIG. 1 at the upper edge. The housing cover 11 can thus serve as a handle during practical handling. The spacer 13 stabilizes the construction and connects the two ends of the handpiece mechanically.

A flexible compressed air feed line (cf. 51 in FIG. 3) leading from a pneumatic compressor to the apparatus is not shown here and is to be connected to the already mentioned connection 3. Analogously, an electronic control line (52 in FIG. 3) from an external controller to the valves 1 and 2 is not shown, which can be designed in a uniform manner with the compressed air feed line.

FIG. 2 shows a longitudinal section along an imaginary central longitudinal axis of the already mentioned cylindrical shape of the overall apparatus, which is at the same time a central longitudinal axis of the projectile guide tube 7. For illustration of the dimensions: in this exemplary embodiment, the length of the projectile guide tube 7 is 145.5 mm and the remaining illustration in FIG. 2 is to scale. In this projectile guide tube, the projectile 8 is shown on the right in FIG. 2 and thus abuts the applicator 6, which is held by the described screw ring 4 and 5 in a manner known per se. In this case, the applicator 6 is elastically mounted in the axial direction by a bellows-like elastomer ring 14 and is pneumatically sealed by a further elastomer ring 12. Alternatively, an apparatus design with regard to the applicator 6 and its holding and sealing according to, for example, EP 2 529 679 (also independently of the cap shown there) or EP 2 095 843 (also independently of the ceramic material discussed there) is also possible and preferred.

FIG. 2 shows on the left an inner channel 21, which connects the pneumatic connection 3 to the first valve 1. The first valve 1 can accordingly switch a supply pressure applied to the pneumatic connection 3, depending on the control, to a radial channel 22, which opens under a damper element 23 and is thus connected to the inner volume of the projectile guide tube 7. Via this channel 22, the projectile is therefore acted upon or accelerated during a first activation time in the direction of the applicator 6. Independently of this, the pneumatic supply pressure is passed on to the second valve 2 via the channel 24 and the pipe 10.

In the second alternative switching position, the channel 22 and thus also the inner volume of the projectile guide tube 7 between the distal end (on the left in FIG. 2) and the projectile 8 are ventilated.

In the second valve 2, which is constructed principally mirror-symmetrically with respect to the first valve 1, the pneumatic supply pressure applied via the pipe 10 can alternatively be passed radially upward via the channel 25 to a volume surrounding the projectile guide tube 7 (to be seen in FIG. 2 as a slot above and below the pipe 7), which leads from the connection of the channel 25 to the right, i.e., in the direction of the applicator 6, and is connected there between the applicator 6 and the end of the projectile guide tube 7 proximal to it to the inner volume of the projectile guide tube 7 (apart from the presence of the projectile 8 shown there in FIG. 2). Via the channel 25, the pneumatic supply pressure can therefore be applied switchably to the inner volume of the projectile guide tube 7 between the applicator 6 and the projectile 8. In this example, however, the pneumatic connection is somewhat poorer as a result of a smaller effective opening cross section than on the opposite side of the projectile guide tube 7, so that, here, at higher air flow speeds (higher frequencies, higher pressures), delays become noticeable earlier or more strongly.

Alternatively, in the other switching position, the second valve 2 can block the connection of the inner volume of the pipe 10 to it and ventilate the channel 25 and thus the inner volume of the projectile guide tube 7 on the right of the projectile 8, i.e., connect it to the external atmosphere via a pneumatically highly conductive connection.

The two valves 1 and 2 can therefore apply pneumatic pressure to the projectile from both sides, namely independently of one another and thus simultaneously or alternately, or can ventilate the interior of the projectile guide tube 7 on both sides.

The reference numeral 30 in FIG. 2 denotes a ring-shaped permanent magnet at the end, which is distal with respect to the applicator 6, of the movement path of the projectile 8 (coinciding with the length of the projectile guide tube 7). With this magnet 30, the projectile 8 constructed from ferromagnetic material can be easily fixed at this distal end of the movement path. By unilateral pressurization by means of the valve 2, the projectile can furthermore be returned to this position and optionally also additionally held there, in particular at the start of operation or in the case of a non-ferromagnetic projectile. In this respect, the permanent magnet 30 can optionally also be omitted, especially when the reflections, which are still to be explained in the further course, at this distal end of the movement path are to be made possible there even at low impact speeds of the projectile 8.

Reference 31 denotes a point at which the passage of the projectile 8 through the corresponding point of the movement path could be detected with a measuring coil, this point lying relatively close to the applicator 6. In the simplest case, a slight residual magnetism of the projectile 8 is used here, but the changing of the inductance of the coil 31 could of course also be detected and evaluated using alternating current technology. The collision of the projectile 8 with the applicator 6 can also be determined by the use of a microphone or movement sensor in the experimental setup. In addition, the impact speed of the projectile 8 can be determined in the experimental setup, for example, with two light barriers positioned just in front of the applicator 6.

FIG. 3 shows a block diagram with the apparatus shown in FIGS. 1 and 2 at the top right, to be precise denoted in summary by the reference numeral 40. This apparatus 40 is a mobile handpiece to be held in the hand, as is already known per se from relevant apparatuses from the prior art. It is connected via two lines 51 and 52 to a base station 50, which contains a pneumatic compressor 53 and a controller 54. The compressor 53 is connected via the line 51, namely a pneumatic flexible hose line, to the handheld apparatus 40 and the controller 54 is connected via the electrical line 52 (optionally integrated with the line 51), via which the controller can access the already mentioned two valves 1 and 2 and supply them with power. In addition, communication with the handpiece 40 can take place via the line 52, in particular if a controller or a part of the controller is additionally provided there.

Moreover, the controller 54 also controls the compressor 53 with respect to its rotational frequency and, of course, the switching on and off and, in turn, is supplied with power by a mains apparatus 55, just like the compressor 53. However, a pressure control influencing the rotational frequency or a control valve can also be integrated in the compressor 53. In addition, the controller 54 is connected to a display 56, which can be installed in the basic apparatus 50 or can also be implemented separately therefrom. The basic apparatus 50 is operated via a touch-sensitive display 56 and/or via an arrangement of buttons, not shown here.

The user can thus control the function of the apparatus 40 on the basis of such buttons and in any case on the basis of the display 56, wherein the controller 54 specifies in particular the opening and closing times and thus also the opening durations of the two valves 1 and 2. Partial tasks of the controller 54 can also be integrated in the handpiece 40, particularly with respect to the controlling of the valves 1 and 2.

For a basic understanding of the controlling of the two valves, reference can be made to the earlier patent EP 2 213 273 B1. With regard to the dimensioning in particular of the projectile guide tube and of the projectile, the exemplary embodiment therein corresponds largely to the above explanations and to FIGS. 1 and 2 with the exception of the existence of the second valve 2 and the omission of the counterpressure chamber. In addition, in the exemplary embodiment cited, a specific valve opening time of the single valve there is assumed at a specific pressure, whereas the projectile acceleration in the present case takes place variably by means of the portion of the first valve opening time also outside the overlap time and therefore also at a constant pressure. For the following explanations, a pressure of 4 bar can be assumed by way of example.

FIG. 4 shows a sequence of four individual schematic time diagrams 4 a) to 4 d) in which the opening and closing process of the first valve 1 is respectively denoted by the solid curve and the opening and closing process of the second valve 2 is analogously denoted by the dashed curve. The increased curve part thus corresponds respectively to the first/second activation time.

FIGS. 4 a) to d) show a succession of pressurization pulses of the two valves 1 and 2 according to the following table of values:

Table Of Values

| | | | | |
|---|---|---|---|---|
| frequency [Hz] | 35 | 35 | 35 | 35 |
| projectile speed [m/s] | 4.3 | 5.4 | 7.3 | 10 |
| opening time valve 1 [ms] | 0 | 0 | 0 | 0 |
| closing time valve 1 [ms] | 9 | 10 | 11 | 13 |
| opening time valve 2 [ms] | 17 | 17 | 17 | 17 |
| closing time valve 2 [ms] | 23 | 23 | 23 | 23 |
| impact time [ms] | 21.6 | 21.3 | 21 | 21.1 |

Specifically, after a respective (shown) collision between the projectile 8 and the applicator 6, on the one hand, as a result of the pulse exchange in this case and, on the other hand, as a result of the pneumatic application during the remaining remainder of the second activation time, the projectile is accelerated in the reverse direction, wherein, however, it is not moved as far as the distal end of the maximum possible movement path, but is braked by the pneumatic counterpressure (in the case of decreasing accelerating pressure) which begins with the following first activation time. As a result, the projectile is ultimately reversed in its movement direction before it reaches the distal end and is accelerated again in the forward direction.

This acceleration ends with the respective end of the first activation time, wherein the projectile continues to fly approximately without force during the then following separation time, in order to collide with the applicator 6 approximately at the same time as the beginning of the following second activation time (or also somewhat earlier or later). The same cycle then follows a further time.

The difference between the four individual illustrations consists in the respectively increasing time durations of the first activation times and thus the decreasing separation times with respect to the second activation times. Consequently, the covered partial path of the maximum possible movement path from FIG. 4 a) to d) increases. Since the accelerating pressure remains the same, the collision speed thus also increases at the same time during the collision with the applicator 6. By selecting different separation times or, not shown here, overlap times, the collision speed can be additionally influenced in this case.

In the case of a typical tube length in the range around 145.5 mm, it can be shown with the values from the table that, at a frequency of 35 Hz, as in this example, only a part of the tube length can obviously still be utilized. Even if the projectile were to keep the collision speed of 4.3 m/s constant during the to-and-fro movement within the tube, a path of 60 mm overall length would only occur in half a circulation time, which is significantly less than the actual tube length. With the previous technology, such high collision frequencies are therefore not possible at comparatively low collision speeds at the same time.

More precisely, FIGS. 4 a) to d) show the electrical control times of the two valves 1 and 2, that is to say the output signals of the controller 54. The valves 1 and 2 are spring-assisted solenoid valves which open purely magnetically and close by the force of the spring which is tensioned in the process when the magnet is no longer loaded. The movements of the valve body are accordingly somewhat delayed with respect to the control signals illustrated, specifically by an estimated 4 ms during opening and 2 ms during closing. The separation times are therefore actually approximately 2 ms longer than illustrated.

In the case of a so-called pilot valve with pneumatic assistance during opening, the situation would be qualitatively comparable.

Of course, in the case of another exemplary embodiment with a “combination valve”, very similar relationships can be generated as illustrated in FIG. 4 in the diagrams a) to d), in which case, however, the overlap time would then mean a different switching state of the valve. Such a combination valve is illustrated schematically in FIG. 5. In this case, the letter K denotes the combination valve, which accordingly replaces the two valves 1 and 2 from FIGS. 1 and 2. Two lines V1 and V2 are illustrated on the right and left, of which V1 means a connection to the left-hand side (according to FIG. 2) of the projectile guide tube 7, for example via the channel piece 22 (analogously to the first valve 1). Accordingly, the right-hand line V2 means a connection to the right-hand side of the projectile guide tube 7 (analogously to the second valve 2), i.e., for example via the channel piece 25.

The upper line is denoted in FIG. 5 by the keyword “pressure supply” and the symbol “1” (not to be confused with the reference numeral 1) for the first valve; analogously, the lower line connection is denoted by the keyword “ambient pressure” and the figure-internal symbol “0”, i.e., means a ventilation opening.

There is a slide S, illustrated symbolically, in the combination valve K, which slide can be displaced in the vertical direction (with respect to FIG. 5) between four different switching positions. In the uppermost position, as illustrated in FIG. 5, the connection V1 is ventilated and the connection V2 is applied with the pneumatic supply pressure, in the third position, from above, vice versa, and in the second position, which has just been switched actively, from above, both connections V1 and V2 are ventilated. Finally, the lowermost position shows a simultaneous pressurization of both connections V1 and V2.

It would therefore be possible to imagine a combination valve K constructed in this or a similar manner instead of the two individual valves 1 and 2 from the exemplary embodiment in FIGS. 1 and 2, wherein the remaining explanations and in particular FIGS. 3 and 4 also apply analogously thereto.

Owing to the possibility of controlling the impact speed of the projectile 8 solely via the switching operation of the two valves 1 and 2, the pneumatic compressor 53 (FIG. 3) runs at a predefined fixed operating frequency at which it has a maximum efficiency. In addition, the pneumatic compressor can be particularly effectively damped in terms of vibration and noise at a predefined operating frequency.

Principally, the control means 54 can vary the impact speed and also the time inter-val between the collisions between the projectile 8 and the applicator 6 from one to the next individual operation. It can therefore influence the impact physics significantly more rapidly and more variably and is in particular not tied to periodic operations.

1. An apparatus for treatment of the human or animal body with mechanical pressure waves, the apparatus comprising:
a projectile guided in the apparatus along the movement path,
an applicator at one end and a stop at another end of the movement path,
pneumatic means for application of pneumatic pressure to the projectile for the purpose of movement along the movement path,
wherein the projectile is adapted for striking onto the applicator for generating the mechanical pressure waves,
which pneumatic means has a double valve means for application of pneumatic pressure to the projectile in the direction towards the applicator during a first activation time and for application of pneumatic pressure to the projectile in the reverse direction during a second activation time and a control means for controlling the double valve means,
wherein the apparatus is adapted, after a partial return movement in a second activation time, to end this second activation time, to start a first activation time and, by the application of pneumatic pressure to the projectile after only a part of the movement path and before the end with the stop, to reverse the movement of the projectile from a return movement into a forward movement.

2. The apparatus according to claim 1, in which the double valve means has a first valve for application of pneumatic pressure to the projectile in the direction towards the applicator and a second valve for application of pneumatic pressure to the projectile in the reverse direction, which valves can preferably be controlled independently of one another by the control means.

3. The apparatus according to claim 1, in which the double valve means has a “combination valve” which, depending on the control by the control means, assumes a first switching state for application of pneumatic pressure to the projectile in the direction towards the applicator or a second switching state for application of pneumatic pressure to the projectile in the reverse direction, wherein in each of these switching states the pneumatic connection used in the respectively other switching state for application of pneumatic pressure to the projectile is ventilated by the combination valve.

4. The apparatus according to claim 2, in which at least one of the two valves is a two-way valve which applies pneumatic pressure to a pneumatic volume between itself and the projectile in a first switching position during the respective activation time for application of pneumatic pressure to the projectile and which ventilates this pneumatic volume in a second switching position.

5. The apparatus according to claim 1, adapted to control an impact speed of the projectile upon impact onto the applicator and in the process to vary the part of the movement path covered by the projectile before the rotation of the movement of the projectile.

6. The apparatus according to claim 1, adapted to allow the first and the second activation time to overlap in an overlap time.

7. The apparatus according to claim 1, in which the control means is adapted to vary in different control states with the overlap time zero a separation time between a first and a second activation time.

8. The apparatus according to claim 1, adapted so that during the control the pneumatic supply pressure applied to the double valve means remains unchanged for the application of pressure.

9. The apparatus according to claim 1, wherein the pneumatic means comprises a pneumatic compressor, wherein the apparatus is adapted to allow the compressor in the activated state to run at different control states with different impact speeds of the projectile at the same rotational frequency, preferably in principle in the activated state to run at always the same rotational frequency.

10. The apparatus according to claim 1, wherein the projectile can be moved with an impact pulse of between 2 gm/s and 300 gm/s upon impact onto the applicator.

11. The apparatus according to claim 1, adapted to vary, in an iterative operating state with directly successive forward movements of the projectile for impact onto the applicator and return movements, the impact speed from one to the next such combined forward and return movement.

12. The apparatus according to claim 1, having a measuring means for detecting a passage of the projectile at a point of the movement path, which measuring means is coupled to the control means.
